(19) United States
(12) Patent Application Publication
(10) Pub. No.: US 2001/0044764 A1
(43) Pub. Date: Nov. 22, 2001

(54) Accepting and processing electronic checks authorized via a public network

(76) Inventor: Thomas A. Arnold, Saratoga, CA (US)

Correspondence Address: Hickman Palermo Truong & Becker, LLP, 1600 Willow Street, San Jose, CA, 95125-5106, US

(21) Appl. No.: 09/766,297

(22) Filed: Jan. 19, 2001

Related U.S. Application Data
(60) Provisional application No. 60/177,014, filed on Jan. 19, 2000.

(51) Int. Cl. G06F 17/60

(52) U.S. Cl. 705/35

(57) ABSTRACT

Techniques are described for processing electronic check payments authorized by an issuer via a public network. Processing an electronic check is initiated when a user supplies, via a client connected to the Internet or other public network, authorization information that authorizes one or more check payments. According to an aspect of the present invention, the authorization information is forwarded to one or more servers that may validate the information and effect settlement of the check. The information is stored and retained in a manner that complies with laws and regulations regarding retention of electronic check authorizations.

### RELATED APPLICATION

This application is related to and claims priority from prior U.S. Provisional Patent Application Ser. No. 60/177,014 filed on Jan. 19, 2000, entitled “Method And Apparatus For Accepting And Processing Electronic Checks Using A Public Network”, by inventor Thomas Arnold, the entire disclosure of which is hereby incorporated by reference as if fully set forth herein.

### FIELD OF THE INVENTION

The present invention generally relates to data processing in the field of electronic commerce. The invention relates more specifically to methods, apparatus, and products for accepting and processing electronic checks using a public network.

### BACKGROUND OF THE INVENTION

Electronic commerce systems, in which buyers can order and pay for products online over the Internet or other public network, have gained wide use throughout the world. Some electronic commerce systems may be used to process transactions with individual consumers, and others may be used to carry out transactions between businesses, known as business-to-business electronic commerce.

The electronic commerce systems that interact with consumers generally collect online orders submitted by the individual consumer over a public data network. Normally, a consumer who wishes to order a product fills out and submits an online form, or answers a series of prompts from the electronic commerce system. The electronic commerce system sends the order information to a merchant that fulfills the order. The merchant may instruct the electronic commerce system to carry out fraud checking or other processes involving the order. If the order is accepted by the merchant, the merchant may instruct the electronic commerce system to process the order for payment so that value is transferred electronically through the banking system from the consumer to the merchant.

The term electronic transaction is used herein to broadly refer to any transaction that includes a stage, such as ordering goods and collecting payment information, that involves a customer of the merchant providing information over the internet. Such information may include information regarding orders or electronic payments. The term merchant is used herein to refer to any individual or organization, usually a business, that furnishes any good, product, or service in exchange for receiving value. A network merchant is merchant who engages in electronic transactions.

The vast majority of electronic commerce transactions have used credit card accounts as a payment mechanism. The consumer provides a valid credit card account number and expiration date value to the merchant as part of the order form, and when the order is accepted, the merchant electronically charges the consumer's credit card account for the value represented by the order.

Credit card payment, however, is not the best payment method for all kinds of electronic transactions. There are many kinds of transactions for which payment by check is preferable. Examples of such transactions include, but are not limited to:

1. Transactions involving a large payment amount. For example, consider a consumer who buys a rare book, stamp, or baseball card using an electronic commerce site or online auction site. Assume the purchased item has a price of $1 million. The consumer is not likely to use a credit card account for payment, because the purchase price would likely exceed any amount of credit that the credit card company is willing to extend to the consumer. However, in a face-to-face transaction the consumer could pay by check.

2. Payment of recurring bills. Residential utility bills for water, electric power, and gas service are commonly paid by check.

3. Payment of an invoice for services rendered. Bills for domestic services or corporate services such as carpet cleaning, plant rental, professional services, etc., are commonly paid by check rather than credit card.

4. Payment of an invoice for services yet to be rendered, such as an advance payment for tax preparation services or legal services.

5. Payment against an open purchase order for goods delivered or yet to be delivered, such as office supplies ordered by a company under an open purchase order.

In all these situations, there is a need for the network merchant to accept check payments. However, in electronic transactions carried out over networks, such as the global, packet-switched network known as the Internet, there is no convenient method by which a network merchant can accept and process an electronic check payment and remain within the rules established by the Electronic Fund Transfer Act of the United States. Under currently accepted business practices, a merchant can accept an electronic check after a check issuer completes either a telephone authorization or electronic facsimile authorization to the merchant. An issuer is the person or entity that authorizes payment of a check and who is debited for the amount of the check. The term receiver is used herein to refer to the entity to whom payment of the check is authorized.

In the United States, numerous laws and regulations govern acceptance of checks. For example, the Automated Clearing House (ACH) network is subject to both federal regulation and industry rules and standards.

The Electronic Funds Transfer Act (Regulation E or Reg E) states that a Preauthorized Electronic Fund Transfer using the ACH from a consumer's account must be authorized by a written signed or similarly authenticated by the consumer, and a copy of the authorization shall be made available to the consumer by the party that obtains the authorization from the consumer. Accordingly, most merchants always obtain a signed or similarly authenticated written authorization from the customer prior to submitting a debit transaction to the ACH system.

Electronic payments among corporations are not subject to Regulation E. However, there must be an agreement between the parties that authorizes a debit from the paying corporation's account.

The use of a facsimile draft by merchants may be subject to the Federal Trade Commission's Telemarketing Sales Rule and/or the Uniform Commercial Code, Title 3.

The FTC's Telemarketing Sales Rule requires a telemarketer to obtain express, verifiable authorization from the consumer in one of the following methods:

1. obtain express, written authorization from the consumer before processing the order,

2. tape-record the authorization, as long as the tape evidences that certain required disclosures were made and the consumer received them, or

3. send written confirmation of the facsimile draft to the consumer prior to submitting the facsimile draft for payment but at the same time the order is processed.

The Telemarketing Sales Rule covers most types of telemarketing calls to consumers, including calls to pitch goods, services, “sweepstakes”, prize promotion and investment opportunities. It will also apply to calls consumers make in response to postcards or other materials they receive in the mail (except catalogs), unless the materials contain the information required to be disclosed under the rule. According to the Federal Trade Commission, the term telemarketing means a plan, program, or campaign which is conducted to induce the purchase of goods or services by use of one or more telephones and which involves more than one interstate telephone call. The term telemarketing does not include:

(a) the solicitation of sales through the mailing of a catalog which contains a written description or illustration of the goods and services for sale; includes the business address of the seller; includes multiple pages of written material or illustrations; and has been issued not less frequently than once a year; or

(b) when the person making the solicitation does not solicit customers by outbound telephone calls, but only receives inbound calls initiated by customers in response to the catalog and during these calls only takes orders without further solicitation.

Title 3, Uniform Commercial Code (UCC), which has been adopted by most states of the United States, applies to merchants choosing facsimile drafts that are exempt from the requirements of the FTC's Telemarketing Sales Rule. The UCC provides that it is legal and acceptable for an individual to verbally authorize a merchant to endorse a check or facsimile draft on his/her account.

These two pre-existing systems can be illustrated in the following examples. As an example of telephone authorization, assume that a consumer calls his mortgage company and requests to make an electronic payment. The representative of the mortgage company reads a script similar to this one:

### Sample Telemarketing Script for U.S. Electronic Check Processing

Telemarketing Representative: Mr. Smith, we are now able to accept checks over the telephone. Would you like to make your payment by credit card or check?

Customer: BY CHECK.

T.R.: I will need to get some information from you so that I can process your sale. Do you have your checkbook available?

Customer: YES or HOW CAN YOU ACCEPT CHECKS OVER THE PHONE?

T.R.: A facsimile draft is created and deposited into our account, and you will be notified of the canceled draft in the same fashion you are notified of your canceled checks today. For example, you may receive the back with in your statement.

Customer: I'M NOT SURE THAT I WANT TO GIVE MY CHECKING ACCOUNT INFORMATION OVER THE PHONE.

T.R.: Well, if you mailed us your check, we would have the same information on hand. This will save you mailing time and postage and you receive a facsimile draft from your bank that confirms the exact amount of your payment.

Customer: IS THAT LEGAL?

T.R.: Yes, under Uniform Commercial Code, Title 1 and Title 3. Verbal agreement is required for authorization.

Customer: OKAY.

T.R.: Do you have your checkbook available?

Customer: YES.

T.R.: Would you please give me your name as it appears on your check?

Customer: JOHN SMITH OR JOHN & NANCY SMITH

T.R.: Now your address on your check?

Customer: 111 YOUR STREET, ANYTOWN, USA

T.R.: What is the check number on the check you are reading from?

Customer: 1234

T.R. Now for the numbers on the bottom of the check. Can you please read the numbers to me from left to right? There is no need to read the bank symbols.

Customer: 01100013193584532121234

T.R. Please read these numbers to me once again to verify this information?

Customer: 01100013193584532121234

T.R. Now please read to me the name of the bank?

Customer: FIRST NATIONAL BANK

T.R. Thank you very much for your time and business and please remember to write the amount of your purchase in your checkbook.

As a second example, prior written authorization is provided for a monthly recurring payment. As an illustration, assume that a consumer is joining a health club that has a monthly membership fee. The consumer fills out a “debit authorization” form. A sample of this form is kept on file by the club and is used as their authorization to make periodic debits from the consumer's checking account according to the membership agreement. All such debit authorizations must have a mechanism for revocation by the consumer.

### Debit Authorization

Authorization Agreement for Preauthorized Payments

[CompanyName]

[ID Number]

I (we) hereby authorize [company name], hereinafter called COMPANY, to initiate debit entries to my (our) checking (chequing) account indicated below at the depository named below, hereinafter called DEPOSITORY, to debit the same to such account.

Depository ____

Name Branch ____

City State ____ State(Province) ____ Zip(Postal Code)____

Routing Number(Bank ID #) ____

Account Number ____

The authorization is to remain in full force and effect until COMPANY has received written notification from me (or either of us) of its termination in such time and in such manner as to afford COMPANY and DEPOSITORY a reasonable opportunity to act on it.

By:(signed) ____

Name(s):(please print) ____

Date signed: ____

All written Debit Authorizations must provide that the receiver may revoke the authorization only by notifying the originator in the manner specified in the authorization.

Although these electronic check payment methods are widely used, neither is well adapted to the use of a public network, such as the Internet, to collect electronic check payments. Based on the foregoing, there is a need for such a service.

In particular, there is a need for a mechanism by which the consumer presenting the online electronic check is legally bound by the same regulations that govern paper checks.

### SUMMARY OF THE INVENTION

Techniques are provided for processing electronic check payments authorized by the issuer via a public network. Processing an electronic check is initiated when a user supplies, via a client connected to the Internet or other public network, authorization information that authorizes one or more check payments. According to an aspect of the present invention, the authorization information is forwarded to one or more servers that may validate the information and effect settlement of the check. The information is stored and retained in a manner that complies with laws and regulations regarding retention of electronic check authorizations.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram depicting an electronic check processing system according to an embodiment of the present invention;

FIG. 1B is a flowchart depicting an overview of an electronic check processing system according to an embodiment of the present invention;

FIG. 2A is a flow chart depicting a process where a merchant application receives and stores authorization information used to process an electronic check payment;

FIG. 2B is a flow chart depicting steps of a process relating to settlement of an electronic payment;

FIG. 3 is a flow chart showing a process where a commerce support server collects and stores authorization information used to process a check according to an embodiment of the present invention;

FIG. 4 is a flow chart showing a process for recurring check payments according to an embodiment of the present invention; and

FIG. 5 is a block diagram depicting a computer system according to an embodiment of the present invention.

### DETAILED DESCRIPTION

A method and apparatus for electronic check processing is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

A method and mechanism is described for processing electronic check payments authorized by the issuer via a public network. Processing an electronic check is initiated when a user supplies, via a client connected to the Internet or other public network, authorization information that authorizes one or more check payments. The authorization information is forwarded to one or more servers that may validate the information and effect settlement of the check. The information is stored and retained in a manner that complies with laws and regulations regarding retention of electronic check authorizations.

### Exemplary Architecture

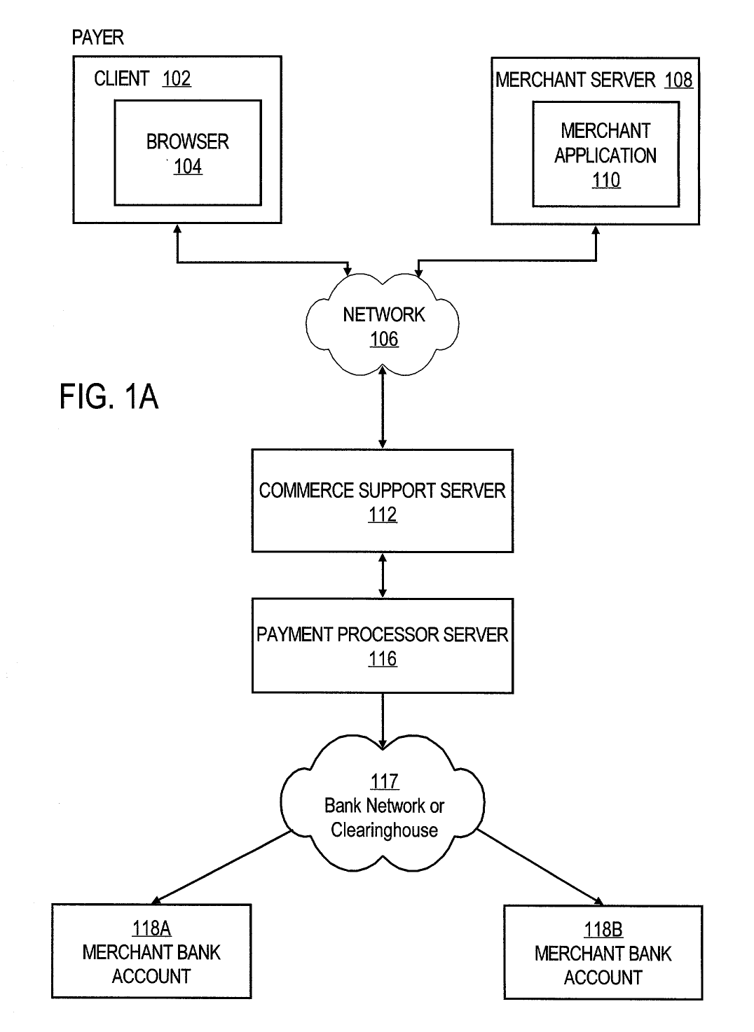

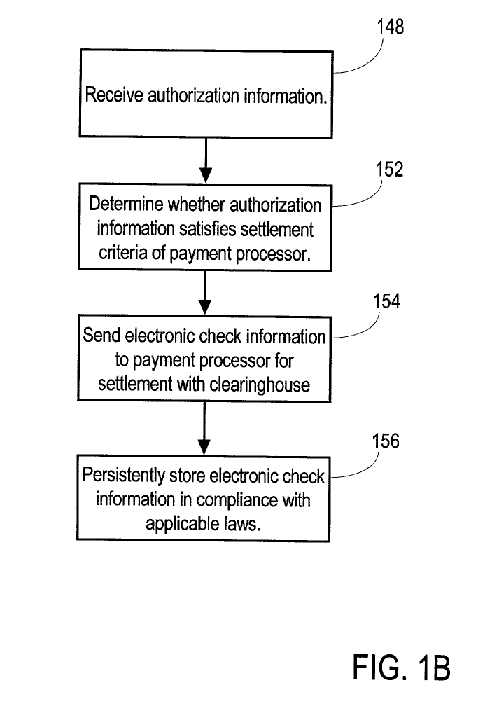

FIG. 1A is a block diagram of an embodiment of an electronic check processing system. A merchant server 108 that executes a merchant application 110 is logically coupled to network 106. Merchant server 108 is one or more hardward or software elements that provides a point of contact between a user of a client connected to merchant server 108 and a network merchant. Merchant server 108 may be located at the network merchant's place of business, but this is not required. Merchant server 108 may be secure commerce support server suitable for use with the World Wide Web, and also includes an HyperText Transfer Protocol (HTTP) server. Microsoft® Internet Information Server is an example of a commercial product that is suitable for use as merchant server 108.

An HTTP server is a server capable of communicating with a browser running on a client using the Hypertext Transfer Protocol to deliver files (“pages”) that contain code and data that conforms to the Hypertext Markup Language (HTML). The HTML pages associated with a server provide information and hypertext links to other documents on that server or (often) other servers. A browser is a software component on a client that requests, decodes, and displays information from HTTP servers, including pages.

The pages provided to the browser of a client may be in the form of static HTML pages. Static HTML pages are created and stored at the HTTP server prior to request from a browser for the page. In response to a request from a browser, a static HTML page is read from storage and transmitted to the requesting browser.

In addition, an HTTP server may respond to browser requests by dynamically generating pages or performing other requested dynamic operations. To perform dynamic operations, the functionality of a HTTP server must be enhanced or augmented by server software. Server software and an HTTP server may interact with each other using, for example, the common gateway interface (CGI) interface protocol.

Many pages transmitted by an HTTP server to a browser contain code that defines graphical user interfaces (GUI). A user may interact with a GUI to enter, for example, textual data or audio data. The text is submitted to an HTTP server as form data. The HTTP server in turn invokes server software, passing the form data as input.

Pages transmitted by HTTP server software may also contain embedded code, scripts, or programs that are executed by the browser or the browser's client. These programs can be, for example, Java applets, Java scripts, or ActiveX controls. The programs may be stored temporarily in the cache of a client, or more permanently as, for example, one or more plug-in applications.

Merchant application 110 is one or more hardware or software elements that cooperate to offer products or services to a network merchant customer, display information about the products or services, and solicit orders for the products or services. The merchant application 110 generally provides the main interface of the merchant to the consumer or user. The merchant application 110 may retrieve and store data about products, services, consumers, and orders in a database that is logically coupled to the merchant server 108 and the merchant application.

Payer client 102 is coupled logically to network 106. A payer client, is any network end station through which a user may engage in an electronic transaction with a server coupled to the network to authorize electronic check payments. Examples of payer clients include work stations, personal computers, or mobile digital devices, such as personal digital assistants or wireless digital phones. Typically, a user of a payer client is an individual consumer that authorizes an electronic payment through the payer client as part of an electronic transaction, to pay for goods or services ordered. However, a user of a payer client is not required to be an individual consumer. A payer client may be an automated software process. In the example of FIG. 1A, for example, a user of a payer client may be a business paying for goods or services ordered or recieved from a network merchant. Payer client 102 is a personal computer which executes a browser 104.

Browser 104 is one or more software or hardware elements that cooperate to read and display electronic documents that are formatted according to open protocols. An example of a commercial product that may be used to implement browser 104 is Microsoft Internet Explorer or Netscape Communicator. Network 106 is a collection of one or more devices and interconnecting elements that support data communications using open protocols. In one embodiment, network 106 is a public, packet switched data network such as the Internet.

Commerce support server 112 is one or more hardware or software elements that service requests of clients, including other servers, to carry out commercial processes or transaction processes. It may be remote from merchant server 108 or co-located with the merchant server. In the preferred embodiment, commerce support server 112 is remote from merchant server 108 and communicates with the merchant server through network 106 using an agreed-upon secure protocol.

An example of an embodiment of commerce support server 112 is one or more servers running Internet Commerce System (ICS), a set of on-demand commerce software applications that provide services that are commercially available from CyberSource Corporation, Mountain View, California. The commerce applications carry out services for each transaction point involved in accepting and fulfilling an order. Commerce support server 112 may include gatekeeping applications and fulfillment services application. Examples of gatekeeping applications include a fraud screen that allows a merchant to determine the level of risk it wishes to accept in order; an export and distribution control application; payment processing applications for receiving and authorizing credit card payments; tax calculation applications; and others. Fulfillment services refers to processes for delivery of a service or product to a customer that ordered them. Examples of fulfillment service applications include secure digital content delivery applicatons, an application that generates shipping invoices and labels, or a messaging application that transmits electronic messages to a shipping application operated by a merchant server or third party fulfillment agent instructing the shipping application to effect delivery.

Commercial applications on commerce support server 112 may be provided by an expert-provider—as either turn key, commercial off the shelf software, or an an off-site server operated by the expert provider. The use of commerce applications provided by such expert providers insulates a merchant from many of the details of carrying out and implementing the functions performed by the commercial applications, such as processing electronic check or credit card payments, or interacting with fulfillment service application and third party fulfillment agents.

Commerce support server 112 is coupled by link 114 to payment processor server 116, which is operated by a payment processor. Link 114 may be a TCP/IP link. Payment processor server 116 is one or more servers or computers configured to carry out check processing to undertake settlement of a check. Generally, payment processor server 116 routes check detail information with the United States Automated Clearing House (ACH) network in order to result in settlement of payment from an account associated with payer client 102 to an account associated with merchant server 108. One or more merchant bank accounts 118A, 118B, maintained at a participating bank, receives payment of funds. Payment processor server 116 may perform basic screening functions before undertaking settlement of the check. Such screening functions include ensuring the validity of the bank account for a check authorization. Payment processor server 116 transmits a message to commerce support server 112 to indicate whether payment processor server 116 will undertake settlement of the check.

Payment processor server 116 may offer on-demand payment processing for other forms of payment, such as credit card payments. Typically, a merchant or other receiver has established an account with the payment processor operating payment processor server 116. A payment processor server 116 receives requests to settle a payment (e.g. check or credit card) transmitted on behalf of the receiver by commerce support server 112. The payment processor server 116 submits the payment to a clearing house, which credits an account associated with the payment processor. The payment processor then credits an account established for the receiver, and then deposits the payment amount in the receiver's merchant account, subtracting a commission for the payment processor's services. An example of a commercial payment processor is Paymentech, Corporation.

To process various forms of payment, a merchant may use multiple payment processors. For example, a merchant may use a particular payment processor for one credit card, and another payment processor for electronic payments or other credit cards. The commerce applications on commerce support server 112 may direct a payment to the appropriate payment processor, insulating a merchant from the details of interacting with multiple payment processors. Before a merchant may use a particular payment processor, commerce support server 112 must be configured to direct settlement of payments for the merchant to the payment processor. This typically involves creating or modify configuration data used to configure and control the commerce support server 112. If commerce support server 112 is a remote server operated by an exper-provider, the merchant may have to establish an account with the expert-provider, who will configure the commerce support server 112 accordingly.

Secure mechanisms are used to transmit data regarding electronic check processing between payer client 102, merchant server 108, commerce support server 112, and payment processor server 116. In addition, merchant server 108 and commerce support server 112 use secure mechanisms to securely store authorization information. Such secure mechanisms may include methods for encryption and policies restricting access to the data.

### Electronic Check Process Overview

FIG. 1B is a flowchart depicting an overview of a process for processing electronic checks. At step 148, authorization information for an electronic check is received in a manner that complies with applicable laws. The information may include a bank routing number, account number, and an amount of an electronic check payment.

At step 152, it is determined whether the authorization information satisfies settlement criteria of a payment processor. At step 154, the check is sent to a payment processor for settlement with a clearinghouse. At step 156, electronic check authorization information is stored in compliance with applicable laws.

An embodiment includes one or more of the following components. The elements shown in FIG. 1A may participate to provide the following components, as described below.

1. A mechanism and system to collect, in an electronic format using a secure interface, information authorizing one or more electronic payments from the issuer at the payer client. Such a mechanism can be provided by browser 104 displaying one or more Web pages that contain code for the GUI and that are download from the merchant server 108 or commerce support server 112.

2. As an alternative to #1: a mechanism and system that uses an electronic wallet stored either on the payer client of the issuer, or a computer system functioning as a server that only the issuer can access, that contains and presents information from the issuer related to their issuer's checking account. An electronic wallet is a combination of software and data that works like a physical wallet during electronic transactions. A wallet can hold a user's payment information, a digital certificate to identify the user, and shipping information to speed transactions. Some wallets will automatically provide shipping inforamtion at the merchant's site. Typically, wallets reside on the user's personal computer, however, they may be placed on a server, such as one operated by a credit card company, or they may even be placed on a mobile digital device.

3. A merchanism and system for capturing the issuer's authorization information across a public network like the Internet, and performing some evaluation of the issuer's submitted information, environmental network information about the issuer's public network connection, historical information about the issuer's buying patterns, and any other information associated with the public network, the Issuer, or the merchant or other Receiver's products or services or Receiver's tolerance to fraud, in order to (a) verify the identity of the Issuer; (b) deternube the rise of fraud to the Receiver; or (c) determine the risk that the Issuer will not make good on the issued check. These functions are typically performed by a commerce support server, such as commerce support server 112.

4. A mechanism and system for delivering the authorization information to a receiver so that the receiver may retain the information according to laws governing its retention. This may be a mechanism that captures information as described in #1 or #2 and then transport it to merchant server 108, or to commerce support server 112, which, in turn, transport the authorization information to merchant server 108. If commerce support server 112 transports the authorization information, the authorization information is rendered in a standard file format, digitally signed by the processork and delivered to merchant server 108.

5. As an alternative to #4 , mechanism and system for delivering the check authorization information to an independent third party, who stores the information on behalf of the receiver. This may be a mechanism that captures information as described in #1 #2 and that transports it to commerce support server 112, or to merchant server 108, which, in turn, transports the authorization information to commerce support server 112. A surrogate unique key is used to identify the authorization information, which is digitally signed by the independent third party, and delivered to the receiver for storage.

6. A mechanism and system for causing delivering of the check authorization information to an automated clearing house on behalf of the receiver. This may be a combination of merchant server 108, commerce support server 112 and payment processor server 116. For example, commerce support server 112 may submit a check payment request on behalf of a merchant to the payment processor server 116, which in turn transmits a request to settle the check to an automated clearing house.

7. A mechanism and system for storing information about the issuer's authorization and period of time the issuer's authorization will remain in force so as to allow recurring check payment transactions. The mechanism in #6 will be instructed to cause delivery of the check payment information according to the check payment information.

8. A mechanism and system for an issuer to revoke said issuer's authorization for recurring debit transactions. This may be a Web page or other GUI that is downloaded by browser 104 from merchant server 108 or commerce support server 112 whereby an issuer may advise the payment processor of their desire to revoke the issuer's prior authorization for recurring debit transactions.

### Electronic Check Procssing Scenarios

There are numerous scenarios amenable to processing check payments authorized via a public network. Some of these scenarios are described below.

1. Alternate payment option to credit cards. For example, for purchases (payers) who do not have a credit card or do not wish to pay to credit card, or when the billed amount would cause the credit limit of a credit card to be exceeded.

2. Payment for services rendered and paid for periodically, for example, monthly, and that can be turned off if the check is returned for non-sufficient funds. Examples of these types of services include utilities (e.g. gas, electric, and telephone).

3. Payment for bills where there is no risk of forfeiture of goods or services provided by the receiver to the issuer if the chek is returned for non-sufficient funds. Examples of these types of bills are government bills, such as property tax bills, or income tax bills.

4. Payment of big ticket items having a price that is too large for most credit card limits. For example, payment for an expensive rare collectable item won in an Web auction, or an automobile ordered through a Web site operated by an automobile dealer.

5. Payment for goods or services that are not tendered before payment for the goods or services are secured. For example, payment for goods ordered over a public network from a network merchant who will not fulfill an order for goods until payment is settled. As another example, payment of a retainer to a law firm that operates a site through which establishment of a living trust is ordered.

6. Recurring billing situations where the issuer has authorized recurring check payments, as in the following examples.

(a) Recurring payments for participation in a subscription service, a service that is provided to a consumer for a periodic fixed fee for as long as the fee is paid in a timely manner. Examples of subscription services include (1) a Web site that provides access to particular content, such as musical titles or business information, or (2) a Web site operated by an organization that provides to subscription members access to discounted products and services.

(b) Recurring payments that are variable, that is, payments that are authorized to occur at a predetermined interval but at amounts that may vary. The amount may depend on the quantity of services or products provided on behalf of the receiver. For example, (1) recurring payments to a merchant that sells office supplies to businesses and charges for them monthly, (2) recurring payments to a merchant who delivers music through a web site and bills based on monthly usage, or (3) recurring payments to a wireless mapping service via a wireless personal data assistant where charges are based on monthly usage.

### Processes for Electronic Check Processing Using Authorization Received Over a Public

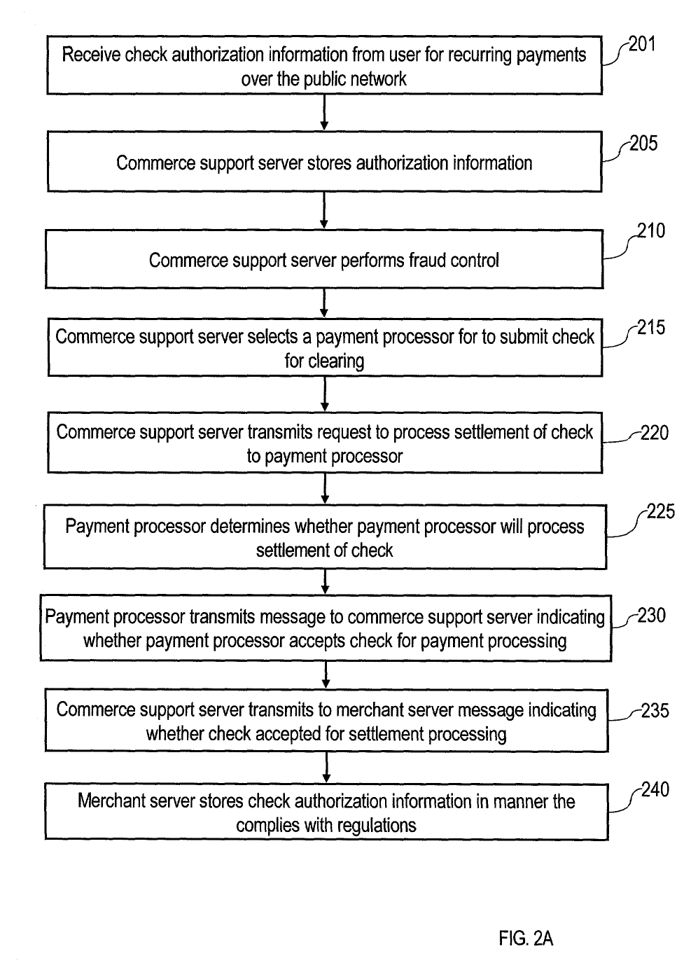

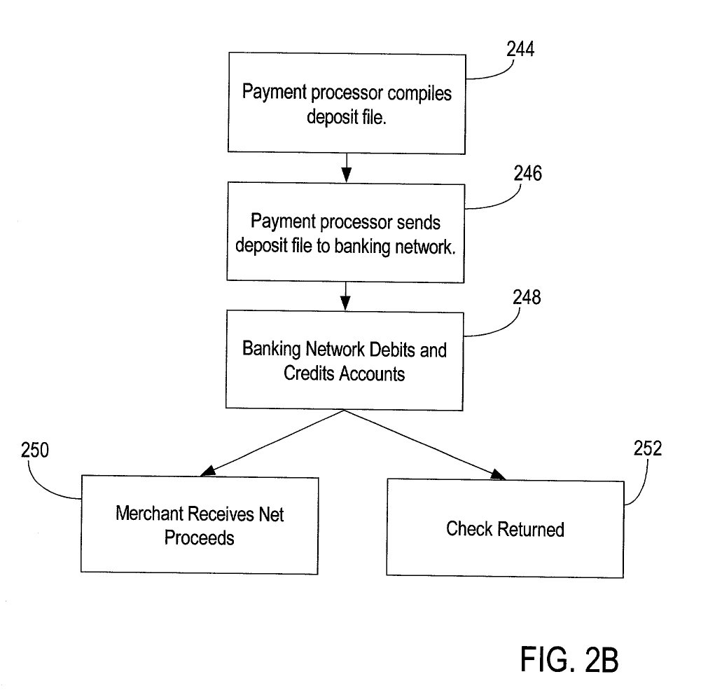

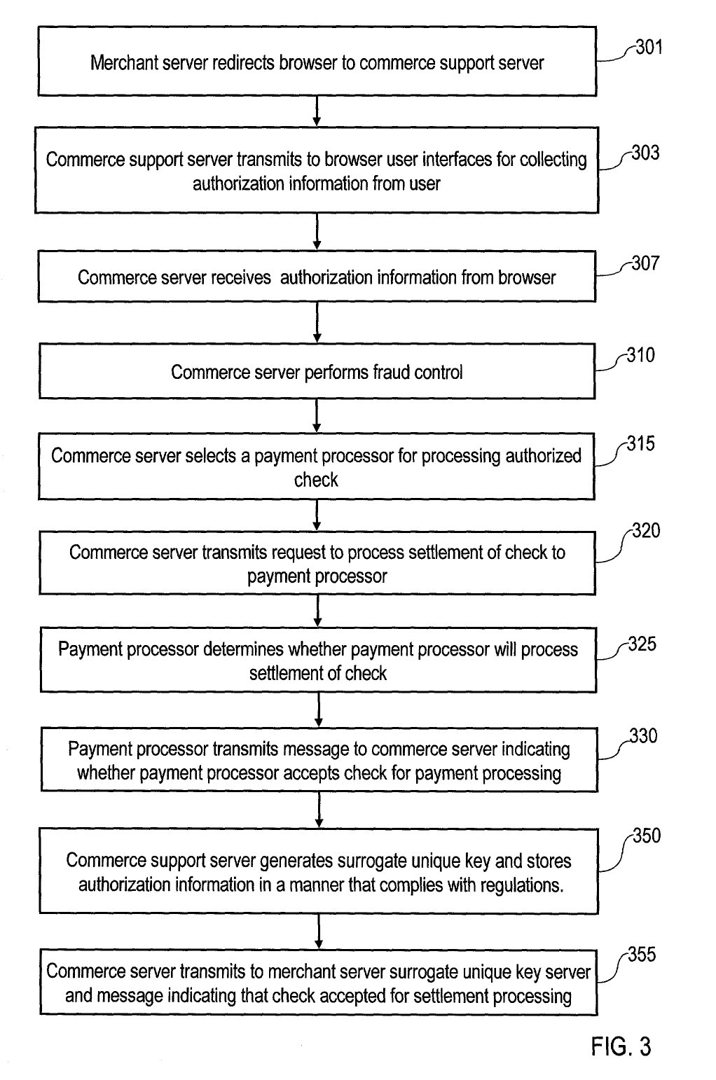

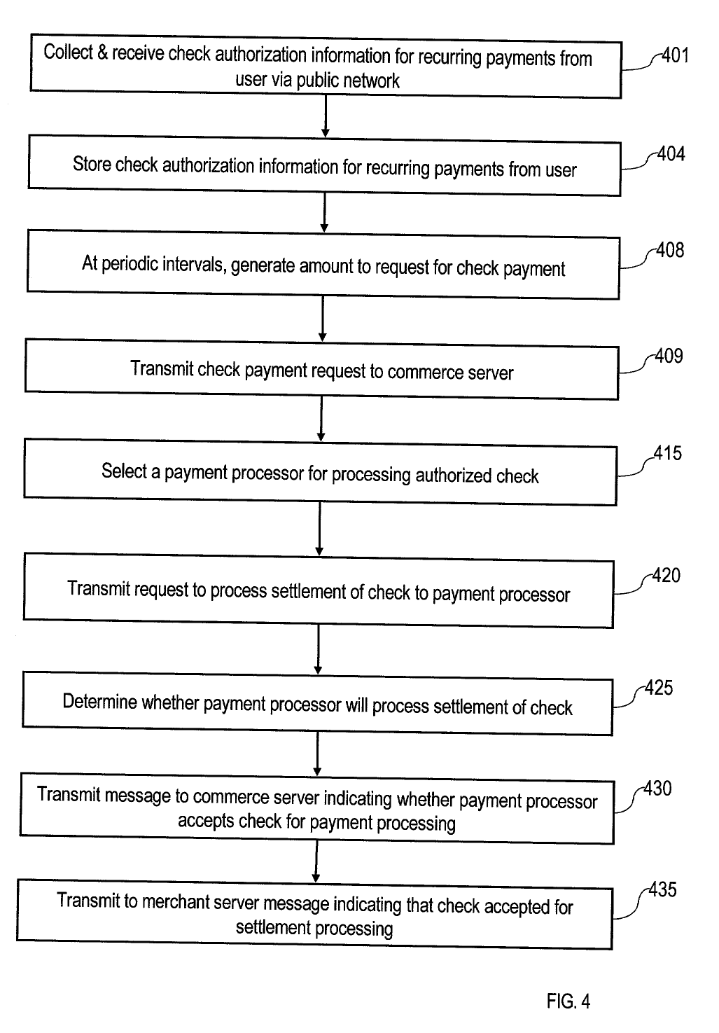

FIG. 2A, FIG. 2B, FIG. 3 and FIG. 4 are flow charts that show processes for processing electronic check payments that are authorized by a user via a public network. FIG. 2A shows a process where a merchant application recieves and stores authorization information used to process a check payment. FIG. 3 shows a process where commerce support server 112 collects and stores authorization information used to process a check. FIG. 4 shows a process for recurring check payments.

The processes depicted in FIG. 2A are illustrated in the context of an electronic transaction between an issuer (customer) and receiver (merchant), where a customer is ordering goods or services and authorizing an electronic check payment. The ordering and authorization information is collected through the use of GUIs transmitted to payer client 102 by merchant server 108. The authorization information includes bank routing information, account numbers, time or authorization, and information indicating that the user manifested authorization for payment.

For purpose of illustration, the GUIs render graphical controls that interact with a user to collect the authorization information at payer client 102. These include graphical controls for collecting bank routing information, the check number, if any, and for allowing a user to manifest authorization for payment. The graphical controls for manifesting authorization could be a pair of command buttons, one corresponding to authorization, one for withholding authorization. The GUI would be configured to transmit authorization information to a merchant server 108 only if a user manipulates the command button for authorization. The authorization information may include the bank routing number and an account number, or the time the user clicked the command button for authorization. A purpose of such an authorization mechanism is compliance with Reg. E.

Referring to FIG. 2A, at step 201 merchant server 108 receives from payer client 102 authorization information collected for the transaction. The authorization information may be included in one or more messages transmitted to commerce support server 112 to request the performance of gatekeeping operations, payment processing operations, or fulfillment operations for the transaction. The message may confirm to open protocols, such as the Simple Commerce Messaging Protocol (SCMP), which is defined in the IETF document “draft-arnold-scmp-07.txt.,” herein incorporated by reference. At step 205, merchant server 108 transmits the authorization information to commerce support server 112, e.g., in an SCMP message. At step 210, the commerce support server 112 performs fraud control operations to ensure that the probability of check fraud for the transaction is sufficiently low. In one embodiment, the merchant may select, on a per-transaction basis, whether the transaction is “validated” or “verified” before deposit. Validation includes format and data edit checks, bank routing number checks, and a comparison to an internal negative file that is maintained by Payment Processor Server 116. Verification compares the transaction to an external negative file to locate accounts that have a history of bad checks outstanding or are closed for cause. Fraud controls also may involve the techniques described in prior U.S. Application No. 09/708,124, entitles “Method And Apparatus For Evaluating Fraud Risk in an Electronic Commerce Transaction”, filed by Michael Lewis, et al. on Nov. 2, 2000, the contents of which are incorporated herein by reference and which is a Continuation-in- part of U.S. Ser. No. 09/442,106, entitled “A Method and System for Detecting Fraud in a Credit Card Transaction Over a Computer Network”, filed by John Philip Pettit on Nov. 17, 1999, the contents of which are incorporated herein by reference and which is a continuation of U.S. Ser. No. 08/901,687, “Method And System For Detecting Fraud in a Credit Card Transaction Over The Internet”, filed by John Philip Petit on Jul. 28, 1997, now U.S. Pat. No. 6,029,154, the contents of which are incorporated herein by reference.

At step 215, commerce support server selects a payment processor to which to submit and clear the authorized check payment. This step may be performed in a variety of ways. For example, the merchant may use only one payment processor. Configuration data of commerce support server 112 specifies the sole payment processor for the merchant. Commerce support server 112 examines the configuration data to determine the payment processor to use for processing the settlement of the authorized check payment. Alternatively, a merchant may use multiple payment processore. Merchant server 108 may specify what payment processor to use by transmitting, in conjunction with information transmitted as step 205, information that specifies what payment processor to use. Or, a payment processor is selected according to pre-established criteria defined by configuration data on commerce support server 112. For example, a merchant may use one payment processor for American currency, and another payment processor for Canadian currency. The configuration data specifies which payment processor is used for which currency. When commerce support server 112 receives authorization information for a particular check authorization, the information specifies the currency. Commerce support server 112 establishes, based on the configuration data and the specified currency, the appropriate payment processor for the check authorization. For purposes of illustration, the payment processor established for this step in this scenario is the payment processor operating payment processor server 116.

At step 220, commerce support server 112 transmits a request to process settlement of the check payment to the selected payment processor.

At step 225, the payment processor (for example, payment processor server 116) determines that it can process settlement of the check.

In one embodiment, block 225 involves performing validation or verification screening for fraud control purposes. Block 225 also may involve determining whether the specified customer account has sufficient funds.

At step 230, payment processor server 116 transmits a message to commerce support server 112 to indicate that the payment processor server 116 will process settlement following a process depicted in FIG. 2B, which shall be later described.

At step 235, commerce support server 112 transmits to merchant server 108 a message indicating that the payment processor server 116 will process the check payment. The message may be a “Approved” or “Declined” message.

At step 240, merchant server 108 persistently stores the authorization information. The authorization information is kept on file by the merchant and is accessible in case of audit or dispute, in accordance with laws and regulations governing the retention of authorization information for electronic checks. Data related to electronic check payment transactions is kept private and confidential. As a result, legal requirements such as those of Reg. E are satisfied.

The above process was illustrated using a check payment transaction that would pass fraud controls at step 210 or would be accepted for payment processing by payment processor server 116 at step 230. These steps perform determinations that will not always have the same outcome. A different outcome will cause execution of a process that does not include all the steps shown in FIG. 2A, or that includes different steps not shown.

For example, if the authorization information failed check processing controls at step 210, then commerce support server 112 transmits a message indicating such failure to merchant server 108, and the remainder of the steps that follow step 210 in the illustration are not executed. Thus, if an electronic check fails the validation or verification process, the transaction is rejected. The merchant may re-present it.

FIG. 2B is a flow diagram showing steps of a process relating to settlement of payment.

In block 244, payment processor server 116 compiles a deposit file representing transactions for a time period. For example, the deposit file may be a daily deposit file representing transactions for one business day. These transactions may include multiple requests to settle check payment transmitted by commerce support server 112 at step 220. In addition, the transactions may include multiple requests to settle check payments issued by various other entities. In block 246, payment processor server 116 sends the daily deposit file to bank network 117 for payment. Typically, banking network 117 is an element of the ACH system.

In block 248, banking network 117 debits and credits appropriate accounts in the appropriate amounts to result in transfer of value. If settlement is successful, a merchant bank account receives net proceeds for the transaction, as indicated in block 250. However, the banking network also may decide to return the electronic check, as indicated in bloc 252. A return may occur at this point, for example, if the status of the account on which the electronic check is drawn has changed between the time at which the steps of block 225 and block 248 are carried out. Checks may be returned for insufficient funds in the drawn account, because the drawn account has been closed, etc.

In one embodiment, a merchant may elect to have the commerce support server deposit the transaction as a facsimile draft.

### Collecting Authorization Information On Behalf Of A Merchant Server

FIG. 3 shows a process where commerce support server 112 collects and stores authorization information on behalf of a receiver merchant. The process is illustrated in the context of a transaction between an issuer customer and a reciever merchant, where the customer is ordering goods or services through the merchant application on merchant server 108. The process is performed after the customer orders the goods or services.

Referring to FIG. 3, at step 301, the merchant server 108 redirects browser 104 to commerce support server 112. The redirection is accomplished by merchant server 108 transmitting data to browser 104 that causes browser 104 to request a GUI from the commerce support server 112, for example, a page containing HTML code that describes a GUI that collects authorization information for a particular electronic transaction.

At step 303, the commerce support server 303 transmits a GUI for collecting authorization information from the user to the browser 104. At step 307, the commerce support server receives authorization information from browser 104. Next, steps 310—330 are executed, in a manner similar to that discussed for steps 210—230, respectively, in reference to FIG. 2A.

At step 350, merchant server 108 generates a key value and stores the authorization information. The authorization information is retained and maintained, and may be accessed in case of audit or dispute, in accordance with laws and regulations governing the retention of authorization information. Thus, in this configuration, the merchant is in compliance with Reg. E.

At step 355, commerce support server 112 transmits the key value to merchant server 108. The key may be used by merchant server 108 to identify authorization information for a particular authorization. A merchant may have to furnish the authorization information to the issuer, when, for example, the issuer disputes payment or requests proof of authorization. The authorization information may be obtained by merchant server 108 by transmitting a request for it back to commerce server 112 that identifies the authorization information using the key.

As an alternate to storing the authorization information on the commerce support server 112, the authorization information may be supplied to merchant server 108 for storage.

### Recurring Payments

FIG. 4 depicts a process for recurring electronic payments that are authorized by a receiver via a public network.

Referring to FIG. 4, at step 401, check authorization information is collected and received from a user via public network. The check authorization information may contain information that specifies the terms for recurring electronic check payments, such as the payee, payment time interval, maximum amount, and the date when authorization expires.

At step 404, the check authorization is stored in compliance with the laws and regulations governing its retention. Steps 401 and 404 may be performed by merchant server 108 or commerce support server 112 using techniques for collecting authorization information similar to any of those discussed herein.

Reg E and the Canadian Payments Association Rule H4 for Pre-Authorized Debits both state that pre-authorized, revocable, electronic fund transfers from a customer's account must be authorized by the customer and a copy of the authorization by made available to the customer. In addition, Rule H4 requires that the customer must specify to the merchant whether such pre-authorized debits are to be made for personal and household purposes, or stored in block 404 is information that conforms to Reg. E. In another embodiment, the information conforms to Rule H4 . Such conformance is achieved by configuring the graphical user interface to present appropriate questions to the user and storing the answers in persistent, retrievable form.

At step 408, at periodic intervals, a request for a check payment for a particular amount is generated, in a manner that conforms to the authorization for recurring check payments. Many techniques may be used to determine the particular amount for a check payment. For example, if payment is for a fixed amount, generating a check payment amount may simply involve accessing the retained check authorization, which specifies the amount for the check payment. For variable check payments, a merchant application may have to determine charges accrued by the receiver for a period of time corresponding to the check payment. For example, a network merchant that supplies office supplies ordered via a public network may execute application that calculate amounts owed by customers based on office supplies delivered to the customer during a period of time.

Either merchant server 108 or commerce support server 112 may perform step 408. However, for variable payments, it is generally preferred that the merchant server 108 or other mechanisms under the control of the merchant generate the variable amounts. Typically, commerce support server 112 lacks access to the information needed to calculate variable check amounts.

At step 409, merchant server 108 transmits a check payment request to commerce support server 112 for the amount calculated at step 408. Of course if commerce support server 112 performs the step of calculating this amount, there is no need to execute step 409. Next, steps 415—435 are executed, in a manner similar to that discussed with respect to steps 210—240, respectively, in reference to FIG. 2A.

### Tying Fulfillment To Settlement Of Check Payment

To protect itself from delivering services or goods that are paid for with an electronic check drawn on an account with insufficient funds, a network merchant may tie fulfillment of ordered services or goods to the settlement of a check payment for them. Tying fulfillment to the settlement may be accomplished using a variety of mechanisms, including the several described below.

For example, the network merchant may operate its own fulfillment application on servers that are coupled to or accessible by merchant server 108. The fulfillment application initiates fulfillment operations for an electronic transaction when merchant server 108 receives a message from the commerce support server 112 that specifies that the electronic payment for the transaction has been settled. Commerce support server 112 transmits the message in response to receiving a message from payment processor server 116 that acknowledges settlement of the check.

As another example, a consumer has ordered an expensive stereo from a network merchant operating merchant server 108, and has paid for the stereo using an electronic check authorized over the Internet by the consumer. The check authorization was processed in a manner previously described. A few days later the payment processor server 116 transmits to the commerce support server 112 a message acknowledging settlement of the check payment, which in turn causes commerce support server 112 to transmit a message to merchant server 108. In response, fulfillment applications on merchant server 108 generate output for shipping, including shipping invoices and labels.

Alternatively, the network merchant may employ a third party fulfillment agent that ships and warehouses goods sold by the network merchant. Fulfillment messaging applications on commerce support server 112 are configured to transmit shipping instructions to the computer system operated by the third party fulfillment agent. The shipping instructions for an electronic transaction are transmitted by commerce support server 112 when it receives an acknowledgement from payment processor server 116 that an electronic check payment for an electronic transaction has been settled.

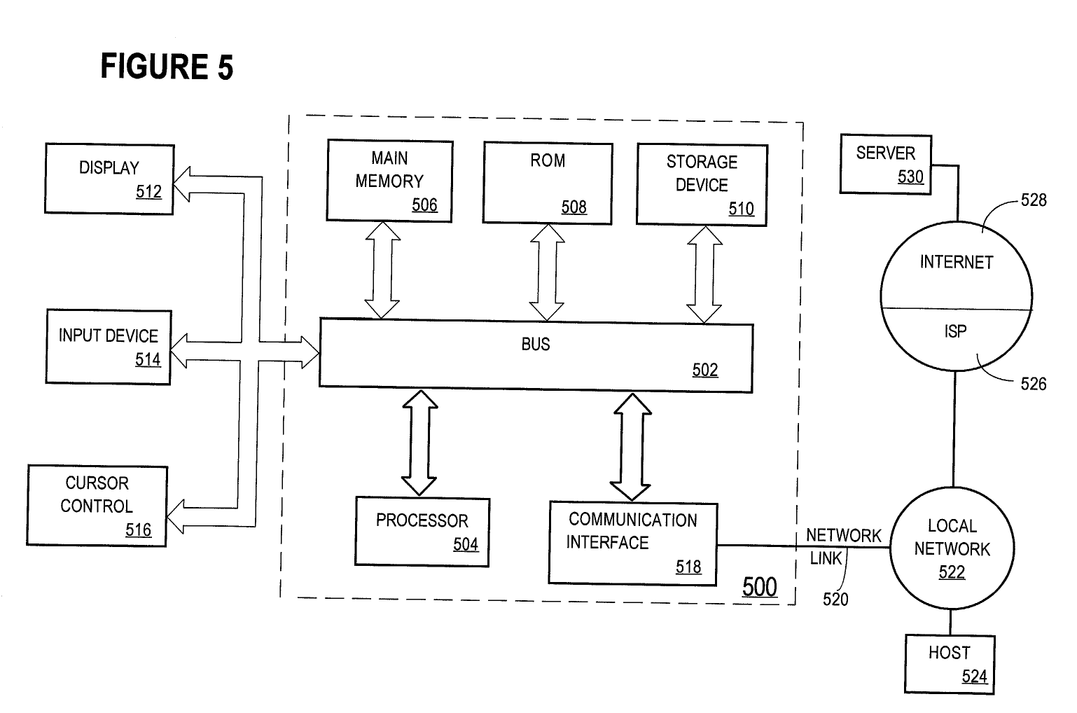

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only (ROM) 508 or other static storage device coupled to bus 502 for storing static information and instructions for processor 504. A storage device 510, such as a magnetic disk or optical disk, is provided and couples to bus 502 for storing information and instructions.

Computer system 500 may be couples via bus 502 to a display 512, such as a cathode ray tude (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprises bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, and other physical medium with patterns of holes, a RAM, a PROM, and EPROM, a FLASK-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk or a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communcation interface 518 sends and receives electrical, electromagnetic or optical signals that carry digital data streams representing various types of information.

Network link 520 typically provides data communication through one or more networks to other data devices. For example, network like 520 may provide a connection through local network 522 to a host computer 524 ot to data equipment operated by an Internet Service Provides (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoind specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for processing electronic check payments that are authorized using public networks in conformance with laws applicable to conventional paper checks, with the method comprising the steps of:
receiving authorization data, including routing and account information, from a client over a public network that is generated base on user input entered by a user during interaction with an user interface executing on said client that authorizes an electronic check payment to a receiver;
determining whether said authorization data satisfies one or more criteria that includes that a payment processor will undertake settlement of said electronic check payment; and
if said payment processor will undertake settlement of said electronic check payment, then causing said authorization data to be recorded persistently to comply with kaws or regulations governing retention of authorizations for electronic check payments.

2. The method of claim 1, wherein a first server performs the steps of establishing a payment processor for settlement of said electronic check payment;
determining whether said authorization data satisfies one or more criteria that includes that said payment processor will undertake said settlement of said check payment for said receiver; and
causing said authorization data to be recorded persistently to comply with laws or regulations governing retention of user authorizations for electronic check payments.

3. The method of claim 2, wherein the step of receiving said authorization data includes said first server receiving via a network said authorization data from a second server operated on behalf of said receiver.

4. The method of claim 2, wherein the step of receiving said authorization data is performed by said first server receiving said authorization data by said client.

5. The method of claim 1, wherein the step of determining whether said authorization data satisfies one or more criteria includes performing fraud control operations to verify said authorization data.

6. The method of claim 1, where the step of determining whether said authorization data satisfies one or more criteria includes performing fraud control, operations to validate said authorization data.

7. The method of claim 2, wherein the step of causing said authorization data to be recorded persistently includes said first server storing one or more records recording said authorization.

8. The method of claim 2, wherein the step of causing said authorization datato be recorded persistently includes said first server transmitting via a network to a second server operated on behalf of the receiver a message indicating that said payment processor will undertake settlement of said check payment.

9. The method of claim 7, further including the steps of:
said first server generating an identifier for said one or more records;
said first server transmitting said identifier to a second server operated on behalf of said receiver.

10. The method of claim 2, wherein the step of causing further includes the step of a first server transmitting via a network to a second server operated on behalf of said receiver a message indicating that said payment processor will undertake said settlement.

11. The method of claim 10, further including the step of said first server transmitting via said network to a third server operated on behalf of said payment processor a request for processing said settlement through an automated clearing house.

12. The method of claim 2, wherein said step of establishing a payment processor includes selecting said payment processor from a plurality of payment processors.

13. The method of claim 12, wherein said check payment requires payment in a particular currency, and wherein said step of selecting said payment processor is based on said currency.

14. The method of claim 10, wherein said authorization data specifies authorization for a series of electronic check payments, and wherein the method further includes the step of said first server initiating settlement of a plurality of electronic check payments according to said authorization.

15. The method of claim 1, wherein said authorization data specifies authorization for a series of electronic check payments, and wherein the method further includes the step of said first server initiating settlement of a plurality of electronic check payments according to said authorization.

16. The method of claim 15, wherein said first server initiates settlement of said plurality of check payments in response to receiving requests, from a second server operated on behalf of said receiver, to initiate settlement of said plurality of check payments.

17. The method of claim 10, further including the step of said first server transmitting to said second server a message indicating that said payment processor has settled said check payment on behalf of said receiver.

18. The method of claim 10, further including the step of said first server receiving via any network from a third server operated on behalf of said payment processor a message indicating that said payment processor has completed said settlement.

19. The method of claim 10, wherein said electronic check payment is associated with an electronic transaction, wherein the method further includes the step of said first server transmitting via any network to another server a request to commence fulfillment of said electronic transaction.

20. The method of claim 19, wherein said first server transmits a request to commence fulfillment of said electronic transaction of another server operating under the control of a third party fulfillment agent of said receiver.

21. The method of claim 2, wherein first server is configured to initiate settlement of credit payments with said payment processor on behalf of said receiver.

22. A method of processing electronic check payments that are authorized using public networks in conformance with laws applicable to conventional paper checks, with the method comprising the steps of:
transmitting, via a public network to a client, code describing a user interface for collecting authorization data representing authorization by a user for an electronic check payment;
receiving said authorization data from said client;
performing fraud control operations to determine risk of fraud associated with said authorization data;
selecting a payment processor for said electronic check payment;
transmitting a message to request settlement of said electronic check payment by said payment processor;
receiving a message indicating that said payment processor will attempt settlement of said electronic check payment;
persistently storing said authorization data in a set of one or more records;
generating an identifier that identifies said one or more records and which may be used to retrieve said one or more records; and
transmitting one or more messages that include said identifier and that indicate that said payment processor is attempting to settle said electronic check payment.

23. A method for processing electronic check payments that are authorized using public networks in conformance with laws applicable to conventional paper checks, with the method comprising the steps of:
receiving via a public network authorization data from a client operated by a user, wherein said authorization data represents user authorization for a plurality of electronic check payments by said user;
persistently storing said authorization data;
generating a plurality of proposed electronic check payments that confirm to said user authorization data; and
for each electronic check payment of said plurality of proposed electronic check payments:
selecting a payment processor for said electronic check payment;
transmitting a message to request settlement of said payment electronic check payment by said payment processor;
receiving a message indicating that said payment processor will attempt settlement of said electronic check payment; and
transmitting one or more messages that indicate that said payment processor is attempting to settle said electronic check payment.

24. A computer-readable medium carrying one or more sequences of instructions for processing electronic check payments that are authorized using public networks in conformance with laws applicable to conventional paper checks, wherein execution of the one or more sequences of instructions by one or more processors causes the one or more processors to perform the steps of:
receiving authorization data, including routing and account information, from a client over a public network that is generated based on user input entered by a user during interaction with an user interface executing on said client that authorizes an electronic check payment to a receiver;
determining whether said authorization data satisfies one or more criteria that includes that a payment processor will undertake settlement of said electronic check payment; and
if said payment processor will undertake settlement of said electronic check payment, then causing said authorization data to be recorded persistently to comply with laws or regulations governing retention of authorizations for electronic check payments.

25. A computer-readable medium carrying one or more sequences of instructions for processing electronic check payments that are authorized using public networks in conformance with laws applicable to conventional paper checks, wherein execution of the one or more sequences of instructions by one or more processors causes the one or more processors to perform the steps of:
transmitting via a public network to a client, code describing a user interface for colleting authorization data representing authorization by a user for an electronic check payment;
receiving said authorization from said client;
performing fraud control operartions to determine risk of fraud associated with said authorization data;
selecting a payment processor for said electronic check payment;
transmitting a message to request settlement of said electronic check payment by said payment processor;
receiving a message indicating that said payment processor will attempt settlement of said electronic check payment;
persistently storing said authorization data in a set of one or more records;
generating an identifier that identifies said one or more records and which may be used to retrieve said one or more records; and
transmitting one or more messages that include said identifier and that indicate that said payment processor is attemtping to settle said electronic check payment.

26. A computer-readable medium carrying one or more sequences of instructions for processing electronic check payments that are authorized using public networks in conformance with laws aaplicable to conventional paper checks, wherein execution of the one or more sequences of instructions by one or more processors causes the one or more processors to perform the steps of:
receiving via a public network authorization data from a client operated by a user, wherein said authorization data represents user authorization for a pluarality of electronic check payments by said user;
persistently storing said authorization data;
generating a plurality of proposed electronic check payments that conform to said user authorization data; and
for each electronic check payment of said plurality of proposed electronic check payments:
selecting a payment processor for said electronic check payment;
transmitting a message to request settlement of said electronic check payment by said payment processor;
receiving a message indicating that said payment processor will attempt settlement of said electronic check payment; and
transmitting one or more messages that indicate that said payment processor is attempting to settle said electronic check payment.

27. A computer system for processing electronic check payments that are authorized using public networks in conformance with laws applicable to conventional paper checks, comprising:
a memory;
one or more processors;
said computer system configures to receive authorization data, including routing and account information, from a client over a public network that is generated based on user input entered by a user during interaction with an user interface executing on said client that authorizes an electronic check payment to a receiver;
said computer system configured to determine whether said authorization data satisfies one or more criteria that includes that a payment processor will undertake settlement of said electronic check payments; and
said computer system configured to cause, if said payment processor will undertake settlement of said electronic check payment, said authorization data to be recorded persistently to comply with laws or regulations govering retention of authorizations for electronic check payments.

28. A computer system for processing electronic check payments that are authorized using public networks in conformance with laws applicable to conventional paper checks, comprising:
a memory;
one or more processors;
said computer system configured to transmit, via a public network to a client, code describing a user interface for collecting authorization data representing authorization by a user for an electronic check payment;
said computer system configured to receive said authorization data from said client;
said computer system configured to perform fraud control operations to determine risk of fraud associated with said authorization data;
said computer system configured to select a payment processor for said electronic check payment;
said computer system configured to transmit a message to request settlement of said electronic check payment by said payment processor;
said computer system configured to receive a message indicating that said payment processor will attempt settlement of said electronic check payment;
said computer system configured to persistently store said authorization data in a set of onr or more records;
said computer system configured to generate an identifier that identifies said one or more records and which may be used to retrieve said one or more records; and
said computer system configured to transmit one or more messages that include said identifier and that indicate that said payment processor is attempting to settle said electronic check payment.

29. A computer system for processing electronic check payments that are authorized using public networks in conformance with laws applicable to conventional paper checks, comprising:
a memory;
one or more processors;
said computer system configured to receive via public network authorization data from a client operated by a user, wherein said authorization data represents user authorization for a plurality of electronic check payments by said user;
said computer system configured to persistently store said authorization data;
said computer system configured to generate a plurality of proposed electronic check payments that conform to said user authorization data; and
said computer system configured to, for each electronic check payment of said plurality of proposed electronic check payments:
select a payment processor for said electronic check payment;
transmit a message to request settlement of said electronic check payment by said payment processor;
receive a message indicating that said payment processor will attempt settlement of said electronic check payment; and
transmit one or more messages that indicate that said payment processor is attemtping to settle said electronic check payment.

30. A computer system for processing electronic check payments that are authorized using public networks in conformance with laws applicable to conventional paper checks, comprising:
a memory;
one or more processors;
means for receiving authorization data, including routin and account information, from a client over a public network that is generated based on user input entered by a user during interaction with an user interface executing on said client that authorizes an electronic check payment to a receiver;
means for determining whether said authorization data satifies one or more criteria that includes that a payment processor will undertake settlement of said electronic check payment; and
means for causing, if said payment processor will undertake settlement of said electronic check payment, said authorization data to be recorded persistently to comply with laws or regulations governing retention of authorizations for electronic check payments.

31. A computer system for processing electronic check payments that are authorized using public networks in conformance with laws applicable to conventional paper checks, comprising:
a memory;
one or more processors;
means for transmitting, via a public network to a client, code describing a user interface for collecing authorization data representing authorization by a user for an electronic check payment;
means for receiving said authorization data from said client;
means for performing fraud control operations to determine risk of fraud associated with said authorization data;
means for selecting a payment processor for said electronic check payment;
means for transmitting a message to request settlement of said electronic check payment by said payment processor;
means for receiving a message indicating that said payment processor will attempt settlement of said electronic check payment;
means for persistently storing said authorization data in a set of one or more records;
means for generating an identifier that identifies said one or more records and which may be used to retrieve said one or more records; and
means for transmitting one or more messages that include said identifier and that indicate that said payment processor is attempting to settle said electronic check payment.

32. A computer system for processing electronic check payments that are authorized using public networks in conformance with laws applicable to conventional paper check comprising:
a memory;
one or more processors;
means for receiving via a public network authorization data from a client operated by a user, wherein said authorization data represents user authorization for a plurality of electronic check payments by said user;
means for persistently storing said authorization data;
means for generating a plurality of proposed electronic check payments that conform to said user authorization data; and
means for processing each electronic check payment of said plurality of proposed electronic check payments, said means for processing including
means for selecting a payment processor for said electronic check payment;
means for transmitting a message to request settlement of said electronic check payment by said payment processor;
means for receiving a message indicating that said payment processor will attempt settlement of said electronic check payment; and
means for transmitting one or more messages that indicate that said payment processor is attempting to settle said electronic check payment.
